(19) United States
(12) Patent Application Publication
(10) Pub. No.: US 2023/0134167 A1
(43) Pub. Date: May 4, 2023

(54) PNEUMATIC TIRE

(71) Applicant: Toyo Tire Corporation, Itami-shi (JP)

(72) Inventors: Masahiro Ueda, Itami-shi (JP); Fumihiko Nakamura, Itami-shi (JP)

(73) Assignee: Toyo Tire Corporation, Itami-shi (JP)

(21) Appl. No.: 17/967,320

(22) Filed: Oct. 17, 2022

(30) Foreign Application Priority Data
Nov. 2, 2021 (JP) 2021-179429
Nov. 2, 2021 (JP) 2021-179430

(51) Int. Cl. B60C 9/00; B60C 9/18; B60C 9/20; D02G 3/48; D02G 3/04

(52) U.S. Cl. CPC B60C 9/005; B60C 9/0042; B60C 9/1821; B60C 9/2009; D02G 3/48; D02G 3/047; B60C 2009/0071; B60C 2009/2019; B60C 2009/2093; D10B 2505/022

(57) ABSTRACT

A pneumatic tire includes: a belt layer including a belt cord is arranged; and a belt reinforcing layer in which an organic fiber cord is arranged, the organic fiber cord is a hybrid cord formed by twisting an aramid yarn and a nylon yarn together, and a ratio (Sr/Sc) of a rubber cross-sectional area (Sr) to a cord cross-sectional area (Sc) is 1.5 to 2.0, and a value obtained by dividing, by 1000, a sum of a product (A) of a load LASE5% (N) at 5% elongation of the organic fiber cord, a cord count (per 25 mm), and the number of belt reinforcing layers, and a product (B) of a load (N) at 0.5% elongation of the belt cord, cos θ in which a belt angle is defined as θ, a cord count (per inch), and the number of belt layers is 11 or more.

### BACKGROUND OF THE INVENTION

### 1. Field of the Invention

The present invention relates to a pneumatic tire.

### 2. Description of the Related Art

For a purpose of improving high-speed durability of a tire, it is known that a belt reinforcing layer in which organic fiber cords such as nylon fiber cords are arranged substantially parallel to a tire circumferential direction is provided on an outer circumferential side of a belt layer (see JP-A-2005-239069, JP-A-2005-75289, JP-A-2003-237309, and JP-A-2017-81349 (Patent Literatures 1 to 4)).

### SUMMARY OF THE INVENTION

In the belt layer, belt cords such as steel cords are arranged to be inclined with respect to the tire circumferential direction, and an angle of each belt cord with respect to the tire circumferential direction is generally set to about 20 degrees. When the angle of the belt cord is set to be larger than usual, for example, to be more than 30 degrees, braking performance on a wet road surface (wet braking performance) and handling stability can be improved. However, when the angle of the belt cord is increased, rigidity of the belt layer in the tire circumferential direction decreases, and thus a ground contact shape is deteriorated, which may lead to a decrease in high-speed durability, ride comfortability, and rolling resistance.

In view of the above points, an object of an aspect of the invention is to provide a pneumatic tire in which high-speed durability, ride comfortability, and rolling resistance are improved while maintaining wet braking performance and handling stability by increasing an angle of a belt cord.

A pneumatic tire according to an aspect of the invention is a pneumatic tire including: a belt layer in which a belt cord is arranged on an outer circumferential side of a carcass layer in a tread so as to be inclined with respect to a tire circumferential direction; and a belt reinforcing layer in which an organic fiber cord is arranged along the tire circumferential direction on an outer circumferential side of the belt layer, in which, in the belt layer, an angle of the belt cord with respect to the tire circumferential direction is more than 30 degrees and 40 degrees or less, the organic fiber cord is a hybrid cord formed by twisting an aramid yarn and a nylon yarn together, the belt reinforcing layer is formed by coating the organic fiber cord with rubber, and a ratio (Sr/Sc) of a rubber cross-sectional area (Sr) to a cord cross-sectional area (Sc) is 1.5 to 2.0, and a value obtained by dividing, by 1000, a sum of a product (A) of a load LASE5% (N) at 5% elongation of the organic fiber cord, a cord count (per 25 mm), and the number of belt reinforcing layers, and a product (B) of a load (N) at 0.5% elongation of the belt cord, cos θ in which a belt angle is defined as θ, a cord count (per inch), and the number of belt layers is 11 or more.

A product of the load LASE5% (N) at 5% elongation of the organic fiber cord and the cord count (per 25 mm) can be 2000 (N/25 mm) or more.

The load LASE5% (N) at 5% elongation of the organic fiber cord can be 65 or more, and the cord count (per 25 mm) can be 23 to 40.

According to the aspect of the invention, by setting the angle of the belt cord to be more than 30 degrees and 40 degrees or less, high-speed durability, ride comfortability, and rolling resistance can be improved while maintaining wet braking performance and handling stability.

### BRIEF DESCRIPTION OF THE DRAWINGS

FIG. 1 is a half cross-sectional view of a pneumatic radial tire according to an embodiment; and

FIG. 2 is a diagram schematically illustrating a part of a cross section of a belt reinforcing layer according to the embodiment.

### DESCRIPTION OF EMBODIMENTS

Hereinafter, an embodiment of the invention will be described in detail.

A pneumatic tire according to the present embodiment is characterized by including a belt layer and a belt reinforcing layer disposed on an outer circumferential side of the belt layer.

The belt layer includes at least one belt ply in which belt cords are arranged so as to be inclined with respect to a tire circumferential direction on an outer circumferential side (that is, an outer side in a tire radial direction) of a carcass layer in a tread.

The belt reinforcing layer is formed of organic fiber cords arranged along the tire circumferential direction (equatorial plane) on the outer circumferential side (that is, the outer side in the tire radial direction) of the belt layer. The organic fiber cords of the belt reinforcing layer extend substantially parallel to the tire circumferential direction, that is, at an angle of approximately 0° (preferably an angle of 5° or less), and the cords are arranged at predetermined intervals in a tire width direction. Such a belt reinforcing layer may be a cap ply that covers the entire belt layer in a width direction, or may be an edge ply that covers an end of the belt.

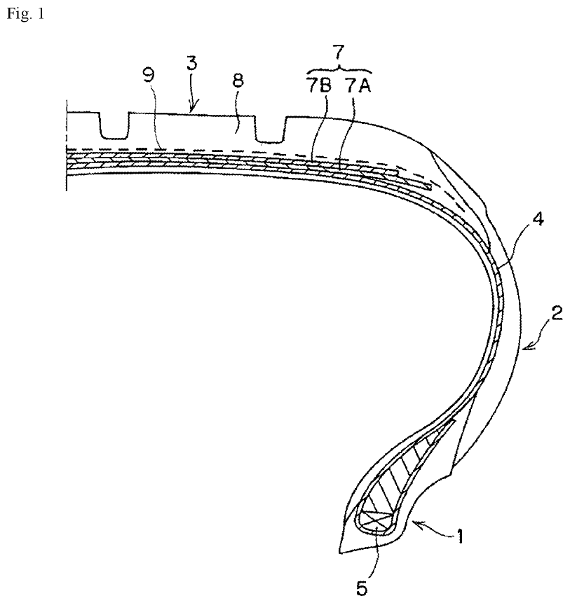

FIG. 1 is a half cross-sectional view of a passenger vehicle pneumatic radial tire that is an example of the pneumatic tire. The tire includes a pair of left and right beads (1) and a pair of left and right sidewalls (2), and a tread (3) provided between the two sidewalls (2), and a carcass layer (4) extending in a toroidal shape is provided between the pair of beads (1).

The carcass layer (4) passes through the sidewalls (2) from the tread (3), and is folded back from an inner side to an outer side at a bead core (5) of the bead (1) so as to be locked. The carcass layer (4) is implemented by at least one ply in which carcass cords made of organic fibers are arranged substantially at right angles with respect to the tire circumferential direction.

A belt layer (7) is disposed on an outer circumferential side of the carcass layer (4) in the tread (3). The belt layer (7) is provided so as to overlap an outer circumference of a crown of the carcass layer (4), and can be implemented by one or a plurality of belt plies. In this example, the belt layer (7) is implemented by two belt plies, that is, a first belt ply (7A) on an inner side and a second belt ply (7B) on an outer side. These belt plies are formed by covering belt cords such as steel cords with rubber. The belt cords are each inclined at a constant angle with respect to the tire circumferential direction and arranged at predetermined intervals in the tire width direction. The belt cords are disposed between the two belt plies (7A) and (7B) so as to intersect one another (that is, so as to be inclined in a left-right symmetrical manner with respect to the tire circumferential direction).

On an outer circumferential side of the belt layer (7), a belt reinforcing layer (9) is provided between the belt layer (7) and a tread rubber (8). In this example, the belt reinforcing layer (9) is a cap ply covering an entire width of the belt layer (7). The belt reinforcing layer (9) is formed of organic fiber cords arranged substantially parallel to the tire circumferential direction, and is formed by coating the organic fiber cords with rubber. The belt reinforcing layer (9) tightens the belt layer (7) in the tire circumferential direction so as to exhibit a hoop effect of improving rigidity in the tire circumferential direction and radial direction and improving a belt binding force, thereby preventing belt lifting, diameter growth, and belt edge distortion caused by a centrifugal force during high-speed traveling and thus improving durability and handling stability at a high speed.

In the present embodiment, in the belt layer, the angle of the belt cord with respect to the tire circumferential direction (hereinafter, also simply referred to as a belt angle) is set to be more than 30 degrees and 40 degrees or less. That is, in a case where the belt layer is formed of one belt ply, a belt angle of the one belt ply is set to be more than 30 degrees and 40 degrees or less, and in a case where the belt layer is formed of a plurality of belt plies, belt angles of the plurality of belt plies in which belt cords are disposed so as to intersect one another are all set to be more than 30 degrees and 40 degrees or less with respect to the tire circumferential direction. By setting the belt angle to be more than 30 degrees, wet braking performance and handling stability can be improved. By setting the belt angle to 40 degrees or less, a decrease in rigidity in the tire circumferential direction can be prevented, and thus a decrease in high-speed durability can be prevented. The belt angle is more preferably 31 degrees or more and 37 degrees or less, and still more preferably 32 degrees or more and 35 degrees or less.

A load LASE0.5% (N) at 0.5% elongation of the belt cord is not particularly limited, and may be, for example, 50 N to 400 N or 100 N to 300 N. The value of the LASE0.5% can be adjusted by, for example, the number of filaments, diameters of the filaments, and carbon contents (mass %) of the filaments.

A cord count E of the belt cord is not particularly limited, and may be, for example, 10 to 40 per inch, 15 to 35 per inch, or 15 to 30 per inch.

The organic fiber cord used in the belt reinforcing layer according to the present embodiment is not particularly limited as long as the organic fiber cord is a hybrid cord formed by twisting an aramid yarn and a nylon yarn together. By using such a hybrid cord, a binding force in the tire circumferential direction can be improved.

Here, examples of the nylon yarn include nylon fibers such as nylon 6, nylon 66, and nylon 46. The aramid yarn may be a para-aramid yarn or a meta-aramid yarn, and a yarn formed of known aramid fibers can be used.

A fineness D of the organic fiber cord is not particularly limited, and may be, for example, 1000 dtex to 4000 dtex, 1500 dtex to 3500 dtex, or 1800 dtex to 3000 dtex. A twist level T of the organic fiber cord is not particularly limited as well, and may be, for example, 20 to 60 per 10 cm, or 25 to 55 per 10 cm. A twist level of a primary twist may be set to the same value as a twist level of a secondary twist.

In the present embodiment, in the belt reinforcing layer, a product (that is, LASE5%×E) of a load LASE5% (N) at 5% elongation of the organic fiber cord and the cord count E (per 25 mm) of the organic fiber cord is preferably 2000 N or more, more preferably 2100 N or more, and still more preferably 2200 N or more. An upper limit thereof is not particularly limited, and may be 5000 N or less, or may be 4000 N or less. When the product of the LASE5% and the cord count E is 2000 N or more, the belt binding force is improved, and excellent high-speed durability, handling stability, and rolling resistance are easily obtained.

The LASE5% of the organic fiber cord may be, for example, 65 N to 200 N, 70 N to 180 N, or 80 N to 160 N. The value of the LASE5% can be adjusted by, for example, selecting the type of the fiber constituting the organic fiber cord, and adjusting the twist level and cord treatment conditions. For example, the LASE5% can be increased by reducing the twist level. In addition, examples of the cord treatment conditions include conditions of a dip treatment in which the organic fiber cord is immersed in a resin solution for an adhesion treatment with rubber (resin solution formulation, treatment temperature, tension, time, and the like). Accordingly, physical properties of the organic fiber cord can be adjusted. For example, when the dip treatment is performed by using a resin solution such as resorcinol formaldehyde latex (RFL) or a blocked isocyanate aqueous solution, the LASE5% can be increased by using a low temperature bath and setting a tension applied to the organic fiber cord to be high. Here, the LASE5% is measured according to JIS L 1017.

The cord count (end count) E of the organic fiber cord can be appropriately set according to the value of the LASE5% such that the product of the LASE5% and the cord count E is in the above range. The cord count E may be, for example, in a range of 23 to 40 per 25 mm.

In the present embodiment, the organic fiber cord obtained in this way is disposed in the belt reinforcing layer such that a ratio (Sr/Sc) of a rubber cross-sectional area (Sr) to a cord cross-sectional area (Sc) is 1.5 to 2.0. When the ratio is 1.5 or more, excellent high-speed durability is easily obtained. In addition, when the ratio is 2.0 or less, an amount of the rubber is reduced, and excellent rolling resistance is easily obtained.

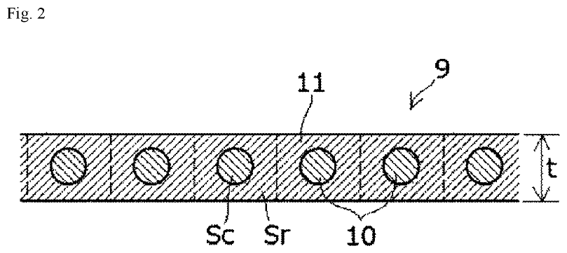

Here, as shown in FIG. 2, the cord cross-sectional area (Sc) and the rubber cross-sectional area (Sr) are cross-sectional areas of an organic fiber cord (10) and a rubber (11), respectively, in a member width direction cross section obtained by cutting the belt reinforcing layer (9) along a width direction thereof. The member width direction cross section is a cross section obtained by cutting the belt reinforcing layer (9) perpendicularly to an extending direction of the organic fiber cord (10). In addition, the ratio (Sr/Sc) can be obtained by dividing the rubber cross-sectional area (Sr) by the cord cross-sectional area (Sc). For example, Sr/Sc per cord (Sr/Sc for each cord partitioned by dotted lines in FIG. 2) is calculated by calculating a cord cross-sectional area per 25 mm width of the belt reinforcing layer (9) from a cord count and a cord diameter of the organic fiber cord (10), calculating a rubber cross-sectional area per 25 mm width from a cross-sectional area of the belt reinforcing layer calculated from a thickness (t) of the belt reinforcing layer (9) and the cord cross-sectional area, and dividing the rubber cross-sectional area by the cord cross-sectional area. When the cord count of the organic fiber cord (10) is constant in the width direction of the belt reinforcing layer (9), the value per cord is used as Sr/Sc of the belt reinforcing layer (9). When the cord count of the organic fiber cord (10) changes in the width direction of the belt reinforcing layer (9), an average value of Sr/Sc of the respective cords calculated as described above may be calculated.

In the present embodiment, the belt layer and the belt reinforcing layer are set such that a value obtained by dividing, by 1000, a sum of a product (A) of the load LASE5% (N) at 5% elongation of the organic fiber cord, the cord count (per 25 mm) and the number of the belt reinforcing layers, and a product (B) of the load LASE0.5% (N) at 0.5% elongation of the belt cord, cos θ in which the belt angle is defined as θ, the cord count, and the number of the belt layers is 11 or more. An upper limit thereof is not particularly limited, and may be 15 or less, or may be 14 or less. When this value is in the above range, a binding force in a belt circumferential direction is improved, a ground contact shape is improved, and thus excellent handling stability, wet braking performance, ride comfortability, and rolling resistance are easily obtained.

Using the belt cord and the organic fiber cord described above, a raw tire (green tire) is prepared in a state in which the belt reinforcing layer is wound around the outer circumferential side of the belt layer, and the obtained raw tire is vulcanized and molded to obtain a pneumatic tire. When the belt layer is formed on the carcass layer, a wide rubberized sheet in which the belt cords are aligned and arranged in an inclined manner may be wound once on the carcass layer. When the belt reinforcing layer is formed on the belt layer, one or a plurality of organic fiber cords may be aligned and covered with rubber, spirally wound on the belt layer of the raw tire, or a wide rubberized sheet in which the organic fiber cords are aligned may be wound once on the belt layer. Preferably, the belt reinforcing layer is wound in a spiral shape in the former manner.

### EXAMPLES

Hereinafter, the invention will be described in more detail with reference to Examples, but the invention is not limited to these Examples.

[Measurement Method and Test Method]

Measurement methods and test methods in Examples are as follows.

(Cord Test Method)

Cord diameter: One organic fiber cord was bent into four portions such that a twist thereof did not untwist, and the four portions were aligned so as not to be slackened and were arranged in parallel, then a measurement was performed using a predetermined dial gauge (a diameter of a leg (measuring element) was 9.5±0.03 mm, a load was 1666±29.4 mN) by dropping the leg from a height of about 6.5 mm.

Cord strength: A load under which a sample was broken was obtained for the organic fiber cord when the organic fiber cord was left to stand for 24 hours under a constant temperature condition of 20° C. and 65% RH and then subjected to a tensile test at 20° C. according to JIS L 1017. A load under which a sample was broken was obtained for the belt cord when a tensile test was performed according to JIS G 3510.

LASE5%: A load at 5% elongation was obtained when the organic fiber cord was left to stand for 24 hours under a constant temperature condition of 20° C. and 65% RH and then subjected to a tensile test at 20° C. according to JIS L 1017.

LASE0.5%: A load at 0.5% elongation was obtained when the belt cord was subjected to a tensile test according to JIS G 3510.

(Tire Test Method)

Belt angle: An angle of the belt cord with respect to the tire circumferential direction on a tire equator (at a center position in the width direction) of the tread was measured for a tire not filled with air.

Tire high-speed durability: The FMVSS 109 (UTQG) standard was used. A steel drum tester having a smooth surface and a diameter of 1700 mm was used, a tire internal pressure was 220 kPa, and a load was 88% of a maximum load specified by JATMA. After break-in traveling at 80 km/h for 60 minutes, the tire was allowed to cool, and after an air pressure was adjusted again, formal traveling was performed. The formal traveling was started from 120 km/h, the speed was increased stepwise by 8 km/h every 30 minutes, and the traveling was continued until a failure occurred. A traveling distance until the occurrence of the failure was expressed as an index with a tire in Comparative Example 1 being 100. A larger index indicates better high-speed durability.

Rolling resistance: Rolling resistance of the tire was measured by using a rolling resistance tester under conditions of a tire internal pressure of 250 KPa, a rim size of 19×7.5 J, a load of 5.6 kN, and a speed of 80 km/h. A reciprocal thereof is expressed as an index with a related example being 100, and a larger index indicated smaller rolling resistance and better fuel economy.

Ride comfortability: Each tire was adjusted to have an internal pressure of 260 kPa using a standard rim of JIS standard, four tires of the same type were mounted on a 2000 cc passenger vehicle made in Japan, ride comfortability was sensory-evaluated by three test drivers on a test course with smooth roads and rough roads, and the evaluation was performed based on Comparative Example 1. Those equivalent to Comparative Example 1 are indicated by “Good”, those worse are indicated by “Poor”, and those better are indicated by “Excellent”.

Actual vehicle handling stability: Test tires each assembled at an internal pressure of 260 kPa were mounted on a test vehicle having an engine displacement of 2000 cc and driven on a test course by three trained test drivers to perform a sensory evaluation. Scores were evaluated on a scale of 1 to 10, and a relative comparison was performed with the tire in Comparative Example 1 being 6 points, and an average point of the three test drivers was expressed as an index with the tire in Comparative Example 1 being 100. A larger index indicates better handling stability.

Wet braking performance: Test tires each assembled at an internal pressure of 260 kPa were mounted on a test vehicle having an engine displacement of 2000 cc, and a water depth on a road surface was set to 1 mm. A distance from when a brake pedal was stepped on at a speed of 100 km/h to when the vehicle stopped was measured, and a reciprocal thereof was expressed as an index with the tire in Comparative Example 1 being 100. A larger index indicates better wet braking performance.

### Examples and Comparative Examples

A passenger vehicle pneumatic radial tire having a tire size of 225/45ZR19 96Y and including the belt reinforcing layer (9) as shown in FIG. 1 was experimentally prepared. A belt angle of a belt layer and a configuration of organic fiber cords constituting the belt reinforcing layer (cap ply) were as shown in Table 1 below for each of tires in Examples and Comparative Examples, and the other configurations were common to all of the tires.

Specifically, as the belt layer, two steel cords of 2+2×0.25 mm were disposed at a belt angle and with a cord count shown in Table 1.

Regarding a cord structure, “1100 dtex/1+940 dtex/1” means a double-twisted structure obtained by twisting together a twisted yarn formed by aramid fibers and having a nominal fineness of 1100 dtex and a twisted yarn formed by nylon fibers and having a nominal fineness of 940 dtex. “1670 dtex/1+940 dtex/1” means a double-twisted structure obtained by twisting together a twisted yarn formed by aramid fibers and having a nominal fineness of 1670 dtex and a twisted yarn formed by nylon fibers and having a nominal fineness of 940 dtex.

The obtained tires were used to evaluate tire high-speed durability, rolling resistance, ride comfortability, actual vehicle handling stability, and wet braking performance. Results are shown in Table 1.

TABLE 1

| | | Comparative | | | | |
|---|---|---|---|---|---|---|
| | | Example 1 | Example 1 | Example 2 | Example 3 | Example 4 |
| Belt | Cord material | Nylon | Aramid/Nylon | Aramid/Nylon | Aramid/Nylon | Aramid/Nylon |
| reinforcing | Cord structure | 1400 | 1100 dtex/1 + | 1100 dtex/1 + | 1100 dtex/1 + | 1670 dtex/1 + |
| layer | | dtex/2 | 940 dtex/1 | 940 dtex/1 | 940 dtex/1 | 940 dtex/1 |
| | Nominal fineness (dtex) | 2800 | 2040 | 2040 | 2040 | 2610 |
| | Final twist level (per 10 cm) | 38 | 36 | 36 | 36 | 30 |
| | Cord diameter (mm) | 0.67 | 0.55 | 0.55 | 0.55 | 0.65 |
| | Cord strength (N) | 220 | 216 | 216 | 216 | 340 |
| | Modulus at 5% elongation | 30.0 | 73.0 | 73.0 | 73.0 | 149.6 |
| | (LASE5%) (N) | | | | | |
| | LASE5% × cord count (N/25 mm) | 915 | 2592 | 2592 | 2592 | 3741 |
| | Member thickness of belt | 1.00 | 1.00 | 0.85 | 0.85 | 0.95 |
| | reinforcing layer (mm) | | | | | |
| | Cord count (per 25 mm) | 30.5 | 35.5 | 35.5 | 35.5 | 25.0 |
| | Ratio (Sr/Sc) of rubber cross- | 1.32 | 1.96 | 1.52 | 1.52 | 1.86 |
| | sectional area (Sr) to cord | | | | | |
| | cross-sectional area (Sc) | | | | | |
| | Number of belt reinforcing layers | 2 | 2 | 2 | 2 | 2 |
| Belt layer | Belt angle (°) | 33 | 33 | 33 | 39 | 33 |
| | Cord strength (N) | 617 | 617 | 617 | 617 | 617 |
| | Modulus at 0.5% elongation | 180 | 180 | 180 | 180 | 180 |
| | (LASE0.5%) (N) | | | | | |
| | Number of belt layers | 2 | 2 | 2 | 2 | 2 |
| | Cord count (per inch) | 21 | 21 | 21 | 21 | 21 |
| | LASE0.5% × cos[belt angle] × | 3170 | 3170 | 3170 | 2938 | 3170 |
| | cord count (N/inch) | | | | | |

| | | | | | |
|---|---|---|---|---|---|
| (A + B)/1000 | 8.2 | 11.5 | 11.5 | 11.1 | 13.8 |
| A = LASE5% × cord count × | | | | | |
| number of belt reinforcing layers | | | | | |
| B = LASE0.5% × cos[belt angle] × | | | | | |
| cord count × number of belt layers | | | | | |
| Tire high-speed durability | 100 | 109 | 103 | 103 | 110 |
| Rolling resistance | 100 | 106 | 108 | 108 | 108 |
| Ride comfortability | Good | Excellent | Excellent | Excellent | Excellent |
| Actual vehicle handling stability | 100 | 128 | 128 | 128 | 133 |
| Wet braking performance | 100 | 106 | 107 | 105 | 108 |

| | | Comparative | Comparative | Comparative | Comparative |
|---|---|---|---|---|---|
| | | Example 2 | Example 3 | Example 4 | Example 5 |
| Belt | Cord material | Aramid/Nylon | Aramid/Nylon | Aratnid/Nylon | Aramid/Nylon |
| reinforcing | Cord structure | 1100 dtex/1 + | 1100 dtex/1 + | 1100 dtex/1 + | 1100 dtex/1 + |
| layer | | 940 dtex/1 | 940 dtex/1 | 940 dtex/1 | 940 dtex/1 |
| | Nominal fineness (dtex) | 2040 | 2040 | 2040 | 2040 |
| | Final twist level (per 10 cm) | 36 | 36 | 36 | 57 |
| | Cord diameter (mm) | 0.55 | 0.55 | 0.55 | 0.59 |
| | Cord strength (N) | 216 | 216 | 216 | 156 |
| | Modulus at 5% elongation | 73.0 | 73.0 | 73.0 | 57.9 |
| | (LASE5%) (N) | | | | |
| | LASE5% × cord count (N/25 mm) | 2592 | 2592 | 2592 | 2057 |
| | Member thickness of belt | 1.10 | 0.80 | 1.00 | 1.00 |
| | reinforcing layer (mm) | | | | |
| | Cord count (per 25 mm) | 35.5 | 35.5 | 35.5 | 35.5 |
| | Ratio (Sr/Sc) of rubber cross- | 2.26 | 1.37 | 1.96 | 1.58 |
| | sectional area (Sr) to cord | | | | |
| | cross-sectional area (Sc) | | | | |
| | Number of belt reinforcing layers | 2 | 2 | 2 | 2 |
| Belt layer | Belt angle (°) | 33 | 33 | 41 | 40 |
| | Cord strength (N) | 617 | 617 | 617 | 617 |
| | Modulus at 0.5% elongation | 180 | 180 | 180 | 180 |
| | (LASE0.5%) (N) | | | | |
| | Number of belt layers | 2 | 2 | 2 | 2 |
| | Cord count (per inch) | 21 | 21 | 21 | 21 |
| | LASE0.5% × cos[belt angle] × | 3170 | 3170 | 2853 | 2896 |
| | cord count (N/inch) | | | | |

| | | | | |
|---|---|---|---|---|
| (A + B)/1000 | 11.5 | 11.5 | 10.9 | 9.9 |
| A = LASE5% × cord count × | | | | |
| number of belt reinforcing layers | | | | |
| B = LASE0.5% × cos[belt angle] × | | | | |
| cord count × number of belt layers | | | | |
| Tire high-speed durability | 105 | 98 | 101 | 101 |
| Rolling resistance | 98 | 108 | 99 | 98 |
| Ride comfortability | Excellent | Excellent | Excellent | Excellent |
| Actual vehicle handling stability | 116 | 122 | 106 | 106 |
| Wet braking performance | 102 | 104 | 100 | 100 |

As shown in Table 1, Comparative Example 2 is an example in which the ratio (Sr/Sc) of the rubber cross-sectional area (Sr) to the cord cross-sectional area (Sc) exceeds the upper limit value, and rolling resistance thereof is worse than that of Comparative Example 1.

Comparative Example 3 is an example in which the ratio (Sr/Sc) of the rubber cross-sectional area (Sr) to the cord cross-sectional area (Sc) is less than the lower limit value, and high-speed durability thereof is worse than that of Comparative Example 1.

Comparative Example 4 is an example in which the belt angle exceeds the upper limit value, as compared to Comparative Example 1, Comparative Example 4 has worse rolling resistance and wet braking performance thereof is not improved.

Comparative Example 5 is an example in which the value of (A+B)/1000 is less than the lower limit value, as compared to Comparative Example 1, Comparative Example 5 has worse rolling resistance and wet braking performance thereof is not improved.

Although certain embodiments of the invention have been described above, these embodiments have been presented as examples only, and are not intended to limit the scope of the invention. These embodiments can be implemented in various other forms, and various omissions, substitutions, and modifications can be made without departing from the gist of the invention. These embodiments and omissions, substitutions, modifications thereof are included in the invention described in the claims and equivalents thereof, as well as being included in the scope and gist of the invention.

### INDUSTRIAL APPLICABILITY

The embodiment of the invention can be suitably used for various pneumatic tires such as a passenger vehicle tire.

### REFERENCE SIGNS LIST

1: bead
2: sidewall
3: tread
4: carcass layer
5: bead core
7: belt layer
8: tread rubber
9: belt reinforcing layer
10: organic fiber cord
11: rubber

What is claimed is:

1. A pneumatic tire comprising:
a belt layer in which a belt cord is arranged on an outer circumferential side of a carcass layer in a tread so as to be inclined with respect to a tire circumferential direction; and
a belt reinforcing layer in which an organic fiber cord is arranged along the tire circumferential direction on an outer circumferential side of the belt layer, wherein
in the belt layer, an angle of the belt cord with respect to the tire circumferential direction is more than 30 degrees and 40 degrees or less,
the organic fiber cord is a hybrid cord formed by twisting an aramid yarn and a nylon yarn together,
the belt reinforcing layer is formed by coating the organic fiber cord with a rubber, and a ratio (Sr/Sc) of a rubber cross-sectional area (Sr) to a cord cross-sectional area (Sc) is 1.5 to 2.0, and
a value obtained by dividing, by 1000, a sum of a product (A) of a load LASE5% (N) at 5% elongation of the organic fiber cord, a cord count (per 25 mm), and the number of belt reinforcing layers, and a product (B) of a load (N) at 0.5% elongation of the belt cord, cos θ in which a belt angle is defined as θ, a cord count (per inch), and the number of belt layers is 11 or more.

2. The pneumatic tire according to claim 1, wherein a product of the load LASE5% (N) at 5% elongation of the organic fiber cord and the cord count (per 25 mm) is 2000 (N/25 mm) or more.

3. The pneumatic tire according to claim 1, wherein
the load LASE5% (N) at 5% elongation of the organic fiber cord is 65 or more, and
the cord count (per 25 mm) is 23 to 40.

4. The pneumatic tire according to claim 2, wherein
the load LASE5% (N) at 5% elongation of the organic fiber cord is 65 or more, and
the cord count (per 25 mm) is 23 to 40.
